(19) United States
(12) Patent Application Publication
(10) Pub. No.: US 2016/0114407 A1
(43) Pub. Date: Apr. 28, 2016

(54) TOOL CLAMPING DEVICE AND COLLET THEREOF

(71) Applicants: FU DING ELECTRONICAL TECHNOLOGY (JIASHAN) CO.,LTD., Zhejiang (CN); HON HAI PRECISION INDUSTRY CO., LTD., New Taipei (TW)

(72) Inventors: XIAO-YI WU, Jiashan (CN); XIAO-HONG ZENG, Jiashan (CN); XIAO-LONG ZHANG, Jiashan (CN); WU YANG, Jiashan (CN); DING-QIANG MA, Jiashan (CN)

(73) Assignees: HON HAI PRECISION INDUSTRY CO., LTD., New Taipei (TW); FU DING ELECTRONICAL TECHNOLOGY (JIASHAN) CO.,LTD., Zhejiang (CN)

(21) Appl. No.: 14/687,363

(22) Filed: Apr. 15, 2015

(30) Foreign Application Priority Data
Oct. 23, 2014 (CN) 201410570112.0

(51) Int. Cl. B23B 31/20

(52) U.S. Cl. CPC B23B 31/202; B23B 2231/2013; B23B 2231/2027

(57) ABSTRACT

A tool clamping device for holding a cutting tool includes a holder having a holding cavity, a lock nut engaged with the holder, and a collet. The collet includes a collet body and a nut mounting part separated from the collet body by an annular concave part. The collet is tapered and has an axle hole in a central portion thereof, and the axle hole running through the collet body, the annular concave part, and the nut mounting part. The collet further includes a plurality of slots extending along an axial direction of the collet. The collet has an inner wall with a plurality of grooves defined therein. A collet is also provided.

### FIELD

The subject matter herein generally relates to a tool clamping device and a collet of the tool clamping device.

### BACKGROUND

In a generally known type of tool clamping device for holding a shank portion of a cutting tool, a lock nut is screwed onto a holder, whereby the lock nut presses a tapered collet into a tapered hole of the holder. At this time, the diameter of the tapered collet is reduced, whereby the tapered collet holds the shank portion. Various such holders have been used in practical applications.

### BRIEF DESCRIPTION OF THE DRAWINGS

Implementations of the present technology will now be described, by way of example only, with reference to the attached figures.

FIG. 1 is an isometric view of one embodiment of a tool clamping device.

FIG. 2 is an exploded view of the tool clamping device in FIG. 1.

FIG. 3 is a cross sectional view of a collet in the tool clamping device in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

The present disclosure is described in relation to a tool clamping device and a collet of the tool clamping device.

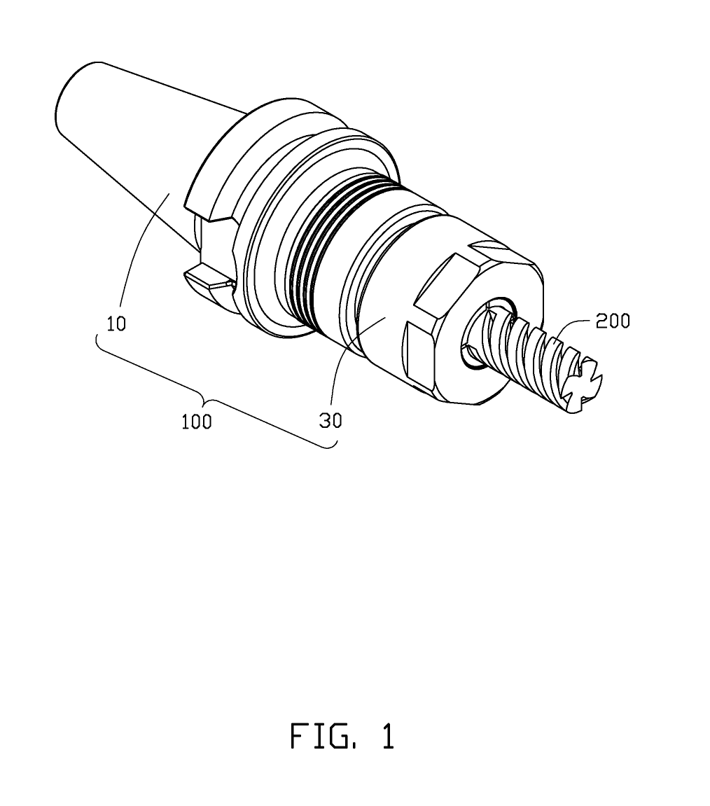

FIG. 1 illustrates that a tool clamping device 100 includes a holder 10 and a lock nut 30. The tool clamping device 100 can be configured to hold a cutting tool 200.

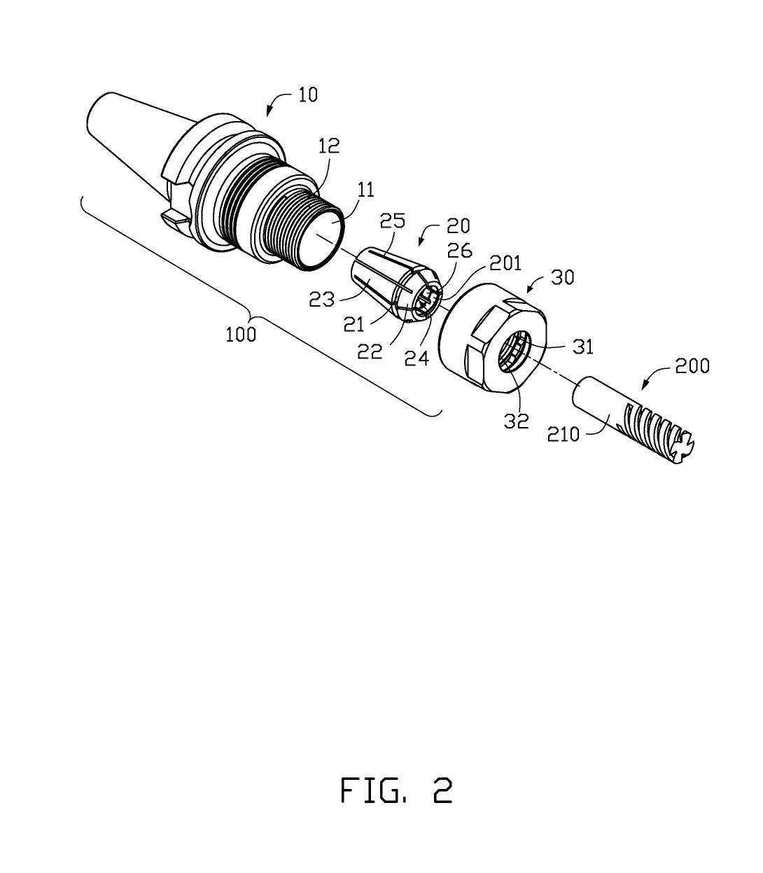

FIG. 2 illustrates that the cutting tool 200 can include a shank portion 210. The holder 10 can include a holding cavity 11 and an outer threaded portion 12 formed on an outer surface of the holding cavity 11. The holding cavity 11 can be substantially tapered and an inner diameter of the holding cavity 11 can decrease along a direction away from the lock nut 30. The lock nut 30 can include an assembly hole 31 and an inner threaded portion 32.

The tool clamping device 100 can further include a collet 20. The collet 20 can be made of an elastic material. The collet 20 can include a nut mounting part 22 and a collet body 23 separated from the nut mounting part 22 by an annular concave part 21. The nut mounting part 22 can be substantially tapered, and an outer diameter can decrease along a direction away from the collet body 23. The nut mounting part 22 can be engaged with the lock nut 30 to clamp the cutting tool 200. The collet body 23 can be substantially tapered, and a diameter of the collet body 23 can decrease along a direction away from the nut mounting part 22. The collet body 23 can be engaged to the holding cavity 11 and configured for inserting the shank portion 210 of the cutting tool 200.

The collet 20 can define an axle hole 24 in a central portion thereof, and the axle hole 24 can run through the nut mounting portion 22, the annular concave part 21, and the collet body 23. The collet 20 can further define a plurality of slots 25. The slots 25 can be evenly arranged in the circumferential direction of the collet 20, and each slot 25 can extend along an axial direction of the collet 20 and communicate with the axle hole 24. One end of the slot 25 can extend to an edge of the nut mounting port 22 or an edge of the collet body 23. The slots 25 can be evenly spaced from each other. The collet 20 with theses slots 25 formed therein can expand or contract its own diameter by means of elastic deformation, thereby releasing or holding the shank portion 210 of the cutting tool 200.

The collet 20 can further include a plurality of grooves 26 arranged in the inner wall 201 thereof. When the cutting tool 200 is inserted in the collet 20, a fraction force between the collet 20 and the cutting tool 200 can be increased caused by the grooves 26.

The lock nut 30 can include an assembly hole 31 and an inner threaded portion 32 arranged in an inner surface of the assembly hole 31. The assembly hole 31 can be configured to assembly the collet 20 and the cutting tool 200, and the inner threaded portion 32 can be screwed on the outer threaded portion 12 of the holder 10, such that the lock nut 30 can be fixed to the holder 10.

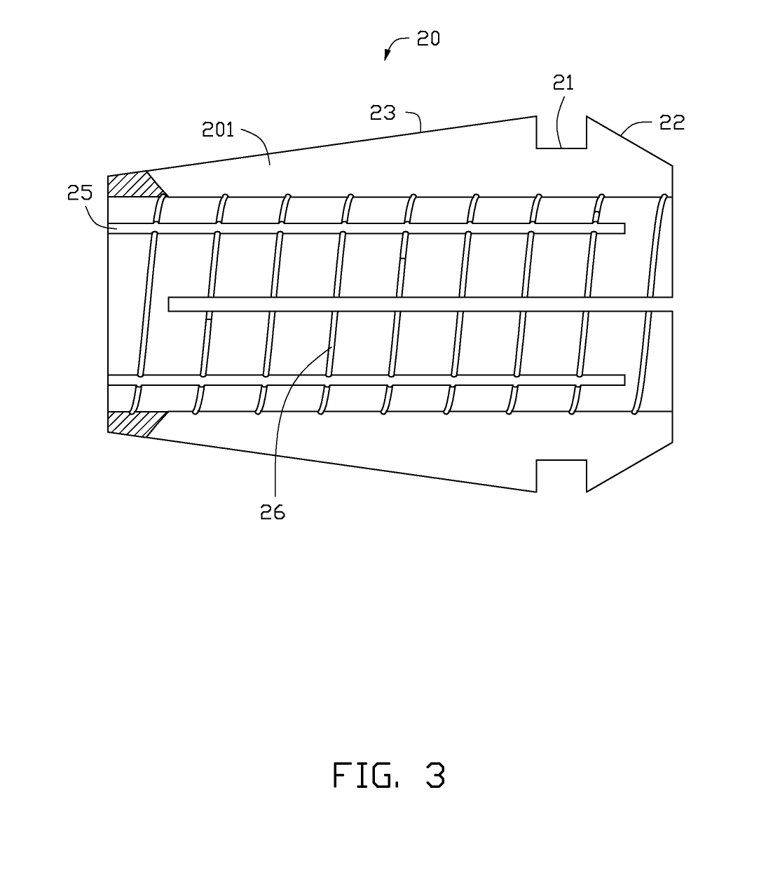

FIG. 3 illustrates that the plurality of the grooves 26 can be arranged on an inner wall 201 of the collet 20. In at least one embodiment, the grooves 26 can be spiral grooves rotating on the axis of the collet 20.

In other embodiments, the grooves 26 can be linear grooves parallel to the axis of the collet 20 and arranged evenly spaced from each other.

In other embodiments, the grooves 26 can be linear grooves can be annular grooves parallel to each other. In other embodiments, the grooves 26 can other shape and can be arranged in random.

In assembling, the nut mounting part 22 of the collet 20 can be assembled in the assembly hole 31 of the lock nut 30, and the shank portion 210 of the tool 200 can be clasped into the collet 20 through the assembly hole 31. Then, the inner threaded portion 32 of the lock nut 30 can be threaded on the outer threaded portion 12 of the holder 10, and the lock nut 30 can be tightly assembled to the holder 10. At this time, the collet 20 can be pressed into the holder 10 and compressed in the radial direction, thereby fixing the tool 200.

The tool clamping device 100 can have the plurality of the grooves 26 on the inner wall of the collet 20, so the fraction force between the collet 20 and the cutting tool 200 can be increased than the conventional collet. Therefore, a grapping force of the tool clamping device 100 can be increased and the tool clamping device 100 can hold the cutting tool 200 stably.

The embodiments shown and described above are only examples. Many details are often found in the art such as the other features of a tool clamping device and a collet. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. A tool clamping device for holding a cutting tool, the tool clamping device comprising:
a holder having a holding cavity defined therein;
a lock nut engaged with the holder; and
a collet comprising a collet body and a nut mounting part separated from the collet body by an annular concave part, the collet having an inner wall with a plurality of grooves defined therein;
wherein the collet is tapered and comprises an axle hole in a central portion of the collet, the axle hole running through the collet body, the annular concave part, and the nut mounting part; and
wherein the collet further comprises a plurality of slots evenly arranged in the circumferential direction thereof, each slot extending along an axial direction of the collet.

2. The tool clamping device as claimed in claim 1, wherein the grooves are spiral grooves rotating on an axis of the collet.

3. The tool clamping device as claimed in claim 1, wherein the grooves are linear grooves.

4. The tool clamping device as claimed in claim 1, wherein the grooves are annular grooves.

5. The tool clamping device as claimed in claim 1, wherein one end of the slot is extending to an edge of the nut mounting portion or an edge of the collet body.

6. The tool clamping device as claimed in claim 1, wherein the nut mounting portion is tapered and a diameter of the nut mounting portion decreases along a direction away from the collet body.

7. The tool clamping device as claimed in claim 1, wherein the collet body is tapered and a diameter of the collet body decreases along a direction away from the nut locking part.

8. The tool clamping device as claimed in claim 1,
wherein the holder comprises an outer threaded portion, and the lock nut comprises an assembly hole and an inner threaded portion; and
wherein the inner threaded portion is configured to threaded on the outer threaded portion to fix the lock nut to the holder.

9. The tool clamping device as claimed in claim 1, wherein the lock nut is configured to be assembled in the holding cavity of the holder, and the collet is configured to assembled in the assembly hole and pressed into the holding cavity.

10. The tool clamping device as claimed in claim 9,
wherein the nut mounting part is engaged to the assembly hole of the lock nut, and the collet body is coupled to the holding cavity of the holder; and
wherein the collet is compressed in a radial direction to hold the cutting tool when the lock nut is screwed on the holder.

11. A collet for holding a cutting tool, the collet comprising:
a collet body and a nut mounting part separated from the collet by an annular concave part;
wherein the collet is tapered and has an axle hole in a central portion of the collet, the axle hole running through the collet body, the annular concave part, and the nut mounting part;
wherein the collet further comprises a plurality of slots evenly arranged in the circumferential direction thereof, each slot extending along an axial direction of the collet and communicate with the axle hole;
wherein an inner wall of the collet defines a plurality of grooves.

12. The collet as claimed in claim 11, wherein the grooves are spiral grooves rotating on an axis of the collet.

13. The collet as claimed in claim 11, wherein the grooves are linear grooves.

14. The collet as claimed in claim 11, wherein the grooves are annular grooves.

15. The collet as claimed in claim 11, wherein one end of the slot is extending to an edge of the nut mounting portion or an edge of the collet body.

16. The collet as claimed in claim 11, wherein the nut mounting portion is tapered and a diameter of the nut mounting portion decreases along a direction away from the collet body.

17. The collet as claimed in claim 11, wherein the collet body is tapered and a diameter of the collet body decreases along a direction away from the nut locking part.
